(19) United States
(12) Patent Application Publication
(10) Pub. No.: US 2013/0022700 A1
(43) Pub. Date: Jan. 24, 2013

(54) CELLULAR ROLLER WITH REINFORCED CUTTING EDGE

(71) Applicants: Robert Sauseng, St. Radegund (AT); Eduard Rauch, St. Margarethen/Raab (AT)

(72) Inventors: Robert Sauseng, St. Radegund (AT); Eduard Rauch, St. Margarethen/Raab (AT)

(73) Assignee: KONIG MASCHINEN GESELLSCHAFT M.B.H., Graz (AT)

(21) Appl. No.: 13/583,205

(22) PCT Filed: Mar. 28, 2011
(86) PCT No.: PCT/EP2011/054756

§ 371 Date: Oct. 4, 2012

(30) Foreign Application Priority Data
Apr. 1, 2010 (AT) A 524/2010

(51) Int. Cl. A21C 5/00

(52) U.S. Cl. 425/289

(57) ABSTRACT

A cellular roller for portioning dough, is provided. The cellular roller comprises a plurality of impeller blades radially extending from a central axis of rotation and having a blade surface made of dough-repellent plastic, which impeller blades between one another define portioning chambers that are open on the outside, wherein each impeller blade at the open blade end thereof is provided with a reinforcement strip made of an abrasion-resistant material.

The invention relates to a cellular roller for portioning dough, which cellular roller comprises a plurality of impeller blades radially extending from a central axis of rotation and having a blade surface made of dough-repellent plastic, which impeller blades between one another define portioning chambers that are open on the outside.

Portioning devices with cellular rollers have been used for a long time for cutting viscous media, such as, for example, for pre-portioning dough or dough ingredients. Usually, there are used cellular rollers made of metal in a welded configuration or of aluminium moulding parts or extruded profiles made of aluminium.

DE 28 19 512 A1 shows, for example, a portioning device for dough, which has a feed shaft, wherein there are arranged a plurality of feed rollers for the dough. At the lower end of the feed shaft, there are present two cellular rollers rotating in the opposite direction to each other and designated as star rollers and having horizontal axes, the drive of which is influenced by a sensor monitoring the amount of dough in the chamber.

In DE 26 34 377 A1 there is described a dough dividing and kneading machine having a dough feed funnel, wherein there are provided several feed roller pairs underneath the dough feed funnel. Downstream of the last feed roller pair, there is arranged a groove roller having cutting edges. The cutting edges are arranged herein essentially in the radial direction to the axis of the groove roller.

These embodiments are disadvantageous insofar as the parts or walls, respectively, of the cellular rollers that contact the dough are made of metal. Using such cellular rollers made of metal, however, there cannot be obtained a satisfying detachment process for the dough, and, hence, undesired adhering of the dough to the cellular rollers cannot be prevented. It is a disadvantage that adhering dough has to be removed from the cellular rollers rather frequently. For this reason, a failure-free and, hence, low-cost operation of such dough dividing devices is, in the majority of the cases, not possible if cellular rollers made of metal are used. Due to the dough residues adhering to the cellular rollers, a reliable and precise portioning of the dough amount is furthermore impaired, constituting another disadvantage of these embodiments.

In order to prevent the disadvantageous adhering of dough portions to the cellular rollers made of metal, the dough-contacted surfaces of the cellular rollers are usually provided with a dough-repellent coating of plastic, for example Teflon (polytetrafluoroethylene, abbrev. PTFE) or Rilsan (ethylene chlorotrifluoroethylenefluoro co-polymer, abbrev. ECTFE).

DE 36 12 615 C2 describes star rollers of a dough portioning device having feed walls made of full and massive material, wherein the feed surfaces of the feed walls are roughened or provided with a pattern, respectively.

The feed walls of the star rollers consist of stainless steel sheets, into which a pattern has been imprinted and which form the dough-contacted feed surfaces themselves or which are covered by a dough-repellent plastic, for example, Teflon. The star rollers have at the free ends of each star arm respective unprofiled outer edges. Alternatively, the star rollers may also be made completely of full or hollow plastic material.

Star rollers, which are made completely of plastic or in which all dough-contacting construction elements are made of plastic, respectively, have a certain advantage due to their dough-repellent adhesion behaviour. The plastic outer edges thereof, however, are not stable enough to withstand the processing of whole grain dough or dough having fruits such as nuts, raisins, cranberries, etc., respectively.

The disadvantage of the cellular rollers coated by plastic is that also these coatings of dough-repellent plastic are only insufficiently protected against abrasive war, caused by solid particles, for example, by grain, nut particles, dried fruit or raisins, which may be present in dough mixtures.

In particular at the projecting outer edges of the cellular rollers, such anti-adhesive, dough-repellent coatings are rather easily damaged, and the basic body made of metal, most frequently a non-ferrous metal, lying underneath, starts to corrode. In particular for use in the food industry with strict food regulations, such cellular rollers, wherein the plastic coatings detach or the basic bodies of which start to corrode, are thus unsuitable.

Especially cellular rollers with a basic body made of non-ferrous metal are exposed to heavy corrosion attack, caused by lactic acids, fruit acids and acetic acids, which are formed in particular in yeast dough. As an alternative, there may be used non-corrosive stainless steel for the production of such basic bodies. Such non-corrosive stainless steel is known to be especially resistant against acid attacks, its use, however, for this application is possible only to a limited extent. Due to the high content of chromium or nickel, respectively, of non-corrosive alloyed stainless steel, the anti-adhesive coatings made of dough-repellent plastic are repelled by the surface of the stainless steel. For this reason, for the production of cellular rollers with a dough-repellent surface, there are preferably used basic bodies made from non-ferrous metals.

Using coated cellular rollers, there has to be paid special attention, in particular for the use in the food industry, to the fact that the coating thereof is formed in an abrasion-resistant way.

From prior art, there are known various methods for permanently reinforce plastic coatings at least at the surface thereof or providing these with wear-resistance, respectively.

For example CH 538 549 states a method of production in order to apply onto exposed edges of construction elements of a plastic construction element wear protection layers made of plastic or layers having fillers made from metallic or ceramic materials. The wear protection layer, in this connection, is applied by means of flame spraying onto an intermediate layer. This intermediate layer has to absorb the thermal influences of the wear protection layers that are applied at temperatures of more than 300° C., and it is absolutely necessary in order to prevent any damage to the plastic construction element situated underneath during the coating process.

Another way to render plastic surfaces resistant is described in EP 655 561 A1 by way of a reinforced plastic roller, which is provided at its surface with a structure, for example a rhombic shaping. In order to prevent the external working surface of the plastic roller from exploding or cracking, there is applied onto the fibre-reinforced basic body of the plastic roller a wear protection layer by means of a thermal spray process. The wear protection layer consists of a synthetic resin matrix adhering to the basic body, e.g., an epoxy resin, which is provided with wear-resistant filler, for example, alumina. Another embodiment variant describes the application of a metal layer, which is also applied onto a surface of an intermediate layer by means of a thermal spray process. The metal layer containing chromium and nickel may then, for example, by way of electrolytic application, be further coated.

Applying such wear protection layers onto plastics or onto metallic basic bodies provided with plastic layers, respectively, is, however, rather complex to produce. The danger of the plastic coating exploding or cracking, in particular in the area of the outer edges of cellular rollers, may be reduced by such wear protection layers, it may, however, not be completely excluded.

The use of ceramic wear protection surfaces, which are, for example, used for sealing areas of pressurized gear locks for dosing bulk, is not suitable for the processing of highly viscous media such as, e.g., dough. Dough disadvantageously strongly adheres to ceramic materials.

Thus, it is the aim of the present invention to provide for a wear-resistant cellular roller with anti-adhesive or dough-repellent, respectively, impeller blades, which prevents the described disadvantages of the prior art.

This aim is solved in a cellular roller according to the preamble of the claim 1 with the features of the characterizing part of the claim 1. The sub-claims relate to further especially advantageous embodiments of the invention.

Especially advantageously, in a cellular roller according to the invention for portioning dough, comprising a plurality of impeller blades radially extending from a central axis of rotation and having a blade surface made of dough-repellent plastic, which impeller blades between one another define portioning chambers that are open on the outside, each impeller blade is provided at the open blade end thereof with a reinforcement strip made of an abrasion-resistant material.

By way of reinforcement strips, which are respectively arranged at the free blade ends of the impeller blades, the blade surfaces made of dough-repellent plastic are especially effectively protected against undesired abrasive wear.

Especially advantageously, each impeller blade is continuously provided along the entire length of its free blade end with a continuous reinforcement strip.

As dough-repellent plastic materials there are suitable, for example, polyethylene (PE), polyoxymethylene (POM) or polypropylene (PP). These plastics excel due to their high density and hardly absorb any moisture.

In a cellular roller according to the invention, the reinforcement strips usefully project beyond the free blade end of each impeller blade in a radial direction by a measured distance of 0.1 to 25 mm, preferably from 0.5 to 5 mm.

By way of the reinforcement strip projecting beyond the free blade end of each impeller blade, the blade surfaces made of plastics are protected against abrasion especially in the area of the free blade ends.

In a cellular roller according to the invention each reinforcement strip advantageously has a fastening profile extending in the longitudinal direction.

There may be provided fastening profiles in the most varied forms and shapes. For example, the reinforcement strips may be used with fastening profiles in T-form, circular form or dove-tail form. Such fastening profiles are intended for a form-fitting and/or firm fixation at the impeller blades. By way of the fastening profiles, there is guaranteed especially advantageously a secure fixation of the reinforcement strips at the impeller blades.

In one variant of the invention, a cellular roller is provided with reinforcement strips, each reinforcement strip having a fastening profile with fastening hooks.

Reinforcement strips with fastening hooks have the advantage that the fastening hooks may be hooked or driven, respectively, into the plastic material of the impeller blades, thus obtaining an especially wear-resistant and form-fitting connection between reinforcement strips and impeller blades.

In a further embodiment variant of a cellular roller according to the invention, the reinforcement strips are each provided with a fastening profile having recesses.

Reinforcement strips that are provided with recesses are especially useful if a die casting process is used for the production of a cellular roller according to the invention. The die cast material is herein insert-moulded through the recesses of the reinforcement strips. In this way, there is obtained an especially secure connection of the reinforcement strips with the surrounding plastic material of the impeller blades.

Reinforcement strips with recesses offer also advantages for, e.g., a firm connection with the surrounding plastic material. An adhesive that provides for a secure connection with the reinforcement strip gets through the recesses of the reinforcement strip to the two lateral faces thereof and thus guarantees secure adhesion.

In a development of the invention, the reinforcement strips of a cellular roller are provided each with a cutting edge along the free longitudinal edges thereof.

This embodiment variant according to the invention has the advantage, in particular in dough portioning devices, wherein there are arranged, e.g., two cellular rollers according to the invention in parallel as well as in opposition to each other, that the individual dough portions are cut off the dough strand especially precisely. The cutting edges at the free front longitudinal edges of the reinforcement strips may have different forms of cut.

In a cellular roller according to the invention, each reinforcement strip is especially advantageously housed in a free longitudinal groove at the free end of each impeller blade.

By way of such a longitudinal groove, a reinforcement strip is especially securely fixed at the free front end of an impeller blade.

In a cellular roller according to the invention, each reinforcement strip is usefully firmly and/or form-fittingly fixed in the longitudinal groove.

In order to firmly connect a reinforcement strip in a longitudinal groove that is provided at the free end of the impeller blade, it may be suitable to glue or weld the reinforcement strip in the longitudinal groove to the plastic material of the impeller blade. Such non-releasable connections are especially resistant. In this way, undesired dislocation of the reinforcement strip will be reliably prevented.

For a form-fitting fixation, the longitudinal groove should be provided with a precisely fitting groove profile corresponding to the fastening profile of the respective reinforcement strip. In order to provide for a detachable connection, a longitudinal groove, for example, that is intended for housing a reinforcement strip with a T-shaped fastening profile also has a corresponding T-shaped groove profile. In this way, a reinforcement strip may, for example, be fixed by insertion into the longitudinal groove, and, if required, it may also be removed from the longitudinal groove for replacement.

Apart from T-shaped fastening profiles, it is also possible to use reinforcement strips as well as the corresponding longitudinal grooves, for example, in a circular form, in a dove-tail form or as a multi-form profile. All other embodiments of a fastening profile are possible that guarantee a firm connection between the reinforcement strip and a longitudinal groove.

Alternatively, reinforcement strips may also be provided with fastening hooks, which are driven or pressed into recesses within the longitudinal groove that are intended especially for this purpose. The fastening hooks, when driven in, cause a deformation of the plastic material in the area of the recesses, and, in this way, there is realized a form-fitting connection between the reinforcement strips and the impeller blades. Such reinforcement strips having fastening hooks, however, may only be removed from the impeller blades by damaging the plastic material.

The reinforcement strips are advantageously made of metal, preferably from a non-corrosive metal.

Reinforcement strips made of metal have the advantage to be especially abrasion-resistant.

Furthermore, the free longitudinal edges of such strips made of metal may be especially easily provided with a cutting edge.

In a preferred embodiment of the invention, the portioning chambers are arranged in a cellular roller in the circumferential direction of the cellular roller at regular distances.

The impeller blades extending in the radial direction from the central axis of rotation form the portioning chambers situated inbetween. Advantageously, the impeller blades are arranged along the circumference of the cellular roller at a regular angle or at regular distances to each other, respectively, so that the portioning chambers situated inbetween may accommodate respectively the same volumes of dough. In this way, a dough strand is advantageously divided batch-wise into defined dough portions of the same size.

Depending on the requirement, cellular rollers may also be embodied with a varying number of portioning chambers. For example, cellular rollers according to the invention may include respectively two, three or four portioning chambers, which are arranged in the circumferential direction of the cellular roller at a regular angle. Also embodiments having a larger number of portioning chambers, for example with eight or more portioning chambers, are conceivable.

In a cellular roller according to the invention, the impeller blades are usefully provided at their respective blade surface at least at some sections with a pattern formed of elevations and/or depressions.

By a pattern at the blade surface, the dough-contacted area is further reduced and, hence, the detachment behaviour of the dough is improved. Undesired adhesion of the dough to the blade surface is thus prevented. A pattern may be formed, for example, by linear or rip-shaped, respectively, elevations and/or depressions, by prismatic or hemispherical elevations and/or depressions or by burled elevations.

Advantageously, in a cellular roller a dough contact area formed by the elevations and/or depressions accounts for 10 to 90%, preferably from 15 to 80% of the impeller blade surface.

Such structured patterns at the blade surface further have the advantage that, due to the structured blade surface, releasing baking agents or releasing oils, which are frequently designated as cutting oils, adhere better to the blade surface and that, for this reason, the separation between the plastic material and the dough is possible very easily and without dough residues adhering. Especially in the case of depressions having a closed volume, as this is the case with a blade surface having a honeycomb structure or hemispherical depressions, there are formed air cushions between the dough and the blade surface. The air cushions furthermore reduce the dough contact area.

In a cellular roller, the plastic is provided preferably anti-bacterial.

Advantageous is also the use of plastics for the production of the blade surface, which is also provided anti-bacterial. The need of maintenance and cleaning is, hence, reduced to a minimum. For dough pieces or products that may be processed with cellular rollers made of an anti-bacterially provided plastic, respectively, there may, in comparison with a treatment with traditional prior-art cellular rollers, preferably be guaranteed a longer “best before” performance.

In an advantageous embodiment variant of the invention, the reinforcement strips in a cellular roller are integrated in an integral basic body made of plastic.

Reinforcement strips may be integrated in an integral basic body, for example, by a forming process, such as milling longitudinal grooves, and a subsequent attachment of the reinforcement strips in the longitudinal grooves, or by an injection moulding process.

In a further useful embodiment the reinforcement strips in a cellular roller according to the invention are insert-moulded by plastic up to a measured distance from the free longitudinal edge thereof.

In order to produce such a cellular roller, the reinforcement strips are, for example, inserted or positioned, respectively, in a separable prototype and subsequently insert-moulded by plastic. There is to be taken care that the plastic only surrounds the reinforcement strips up to a defined measured distance from the free longitudinal edge.

In a development of the invention, the reinforcement strips in a cellular roller are connected with a central support body, for example, by welding or integrally.

The invention includes most varied embodiments of a cellular roller according to this type. In order to increase the rigidity, cellular rollers may, e.g., be provided with a support body, onto which the reinforcement strips are fixed, e.g., by welding.

Alternatively, a support body may also be integrally formed so that reinforcement strips are part of the support body. This is, for example, obtained by way of a support body with a central tube section, at which approximately star-shaped reinforcement strips are arranged in the radial direction from a central axis of rotation.

Such a support body is preferably made of metal, in particular a hardened metal.

Further features of the invention become obvious by way of the subsequent description of exemplary embodiments and in reference to the drawings.

In schematic depictions there is respectively shown:

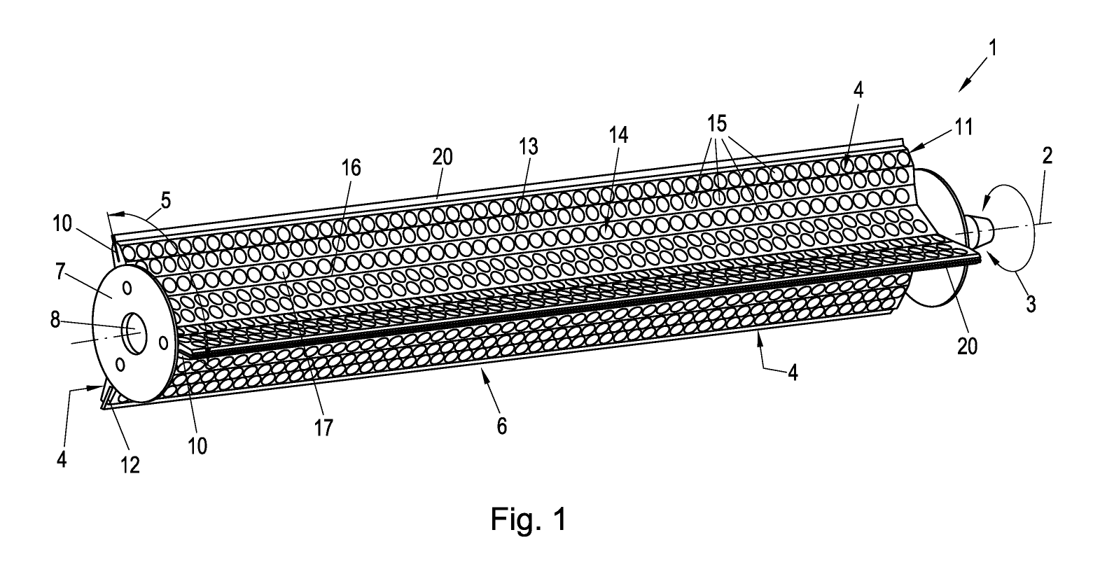

FIG. 1 shows a first embodiment of a cellular roller according to the invention in an inclined view;

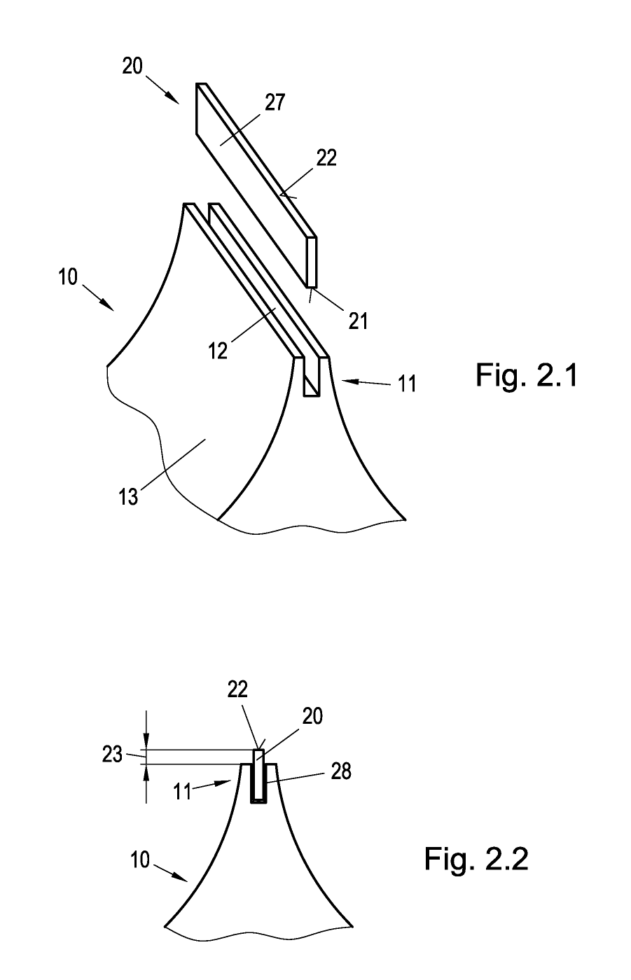

FIG. 2.1 shows in an exploded inclined view a detail of a reinforcement strip;

FIG. 2.2 shows in a profile view the reinforcement strip shown in FIG. 2.1 in the assembled condition, attached in a longitudinal groove of an impeller blade;

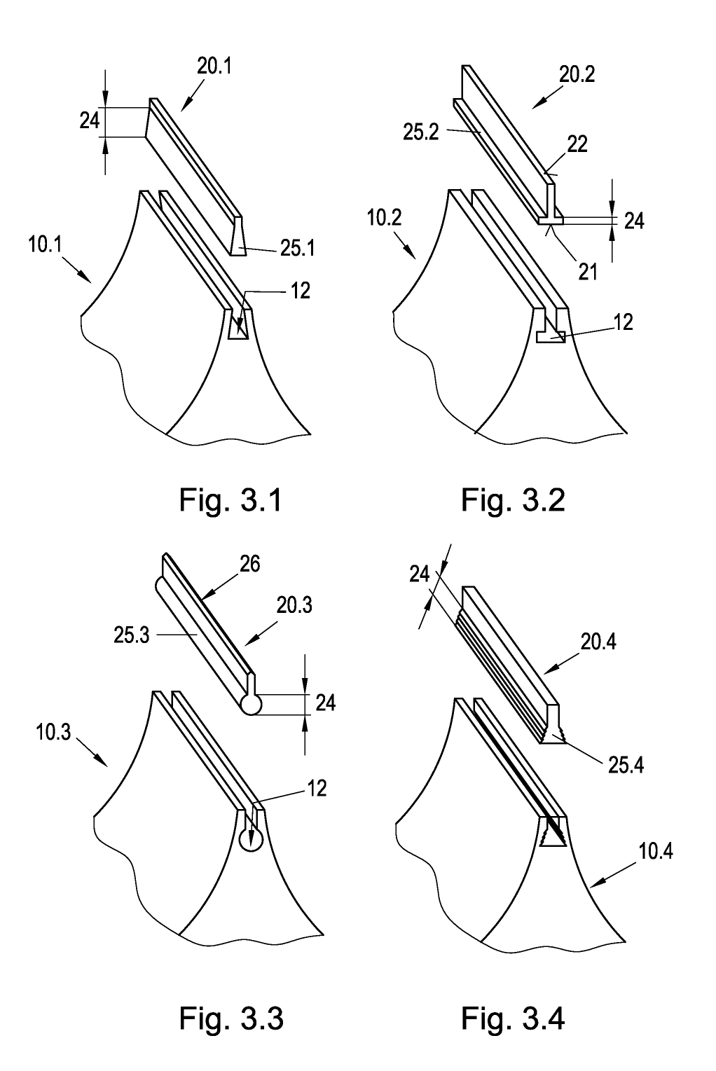

FIG. 3.1 to FIG. 3.4 each show in exploded views reinforcement strips having each differently formed fastening profiles;

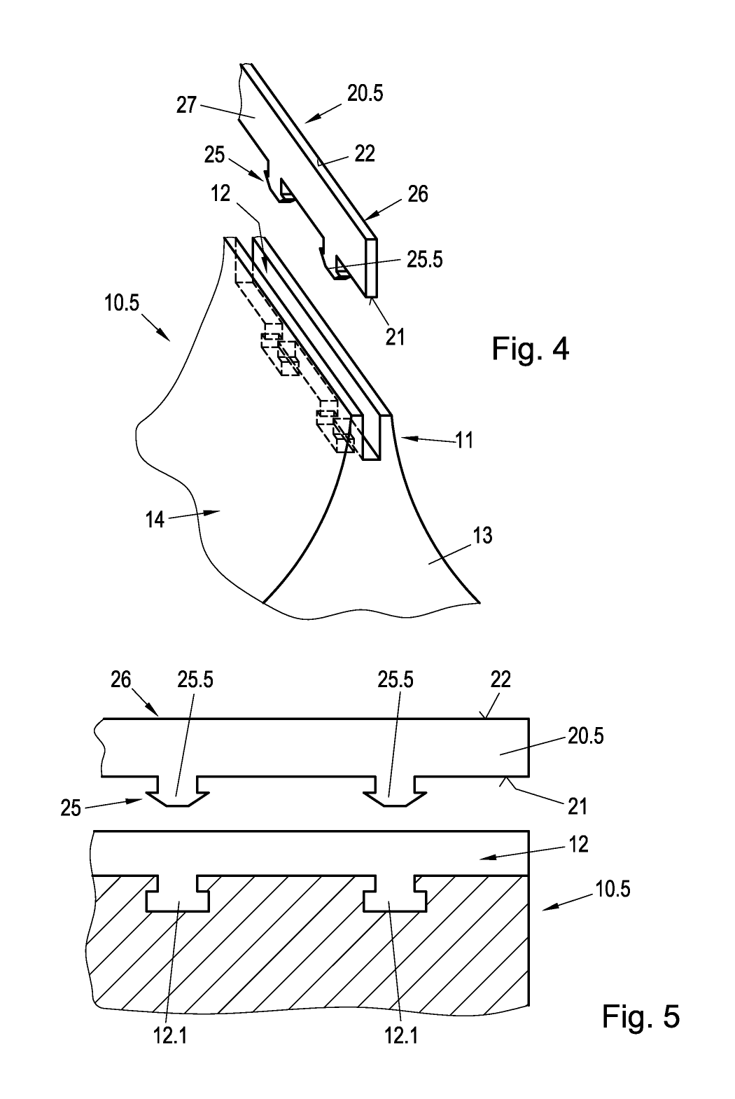

FIG. 4 shows in an exploded view another embodiment of a reinforcement strip provided with a fastening profile;

FIG. 5 shows in a sectional view a detail of the reinforcement strip shown in FIG. 4;

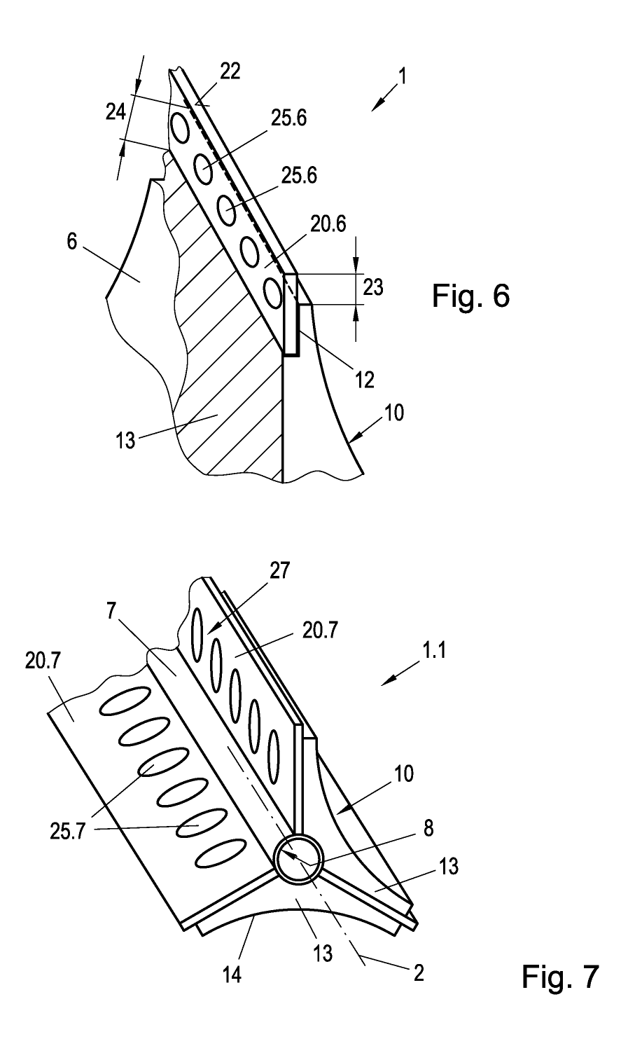

FIG. 6 shows in an inclined view a partial section of a reinforcement strip insert-moulded by way of an insert moulding process as well as the adjoining impeller blade;

FIG. 7 shows in an inclined, partly cut-out view another embodiment of a cellular roller according to the invention having a central support body that is insert-moulded by plastic;

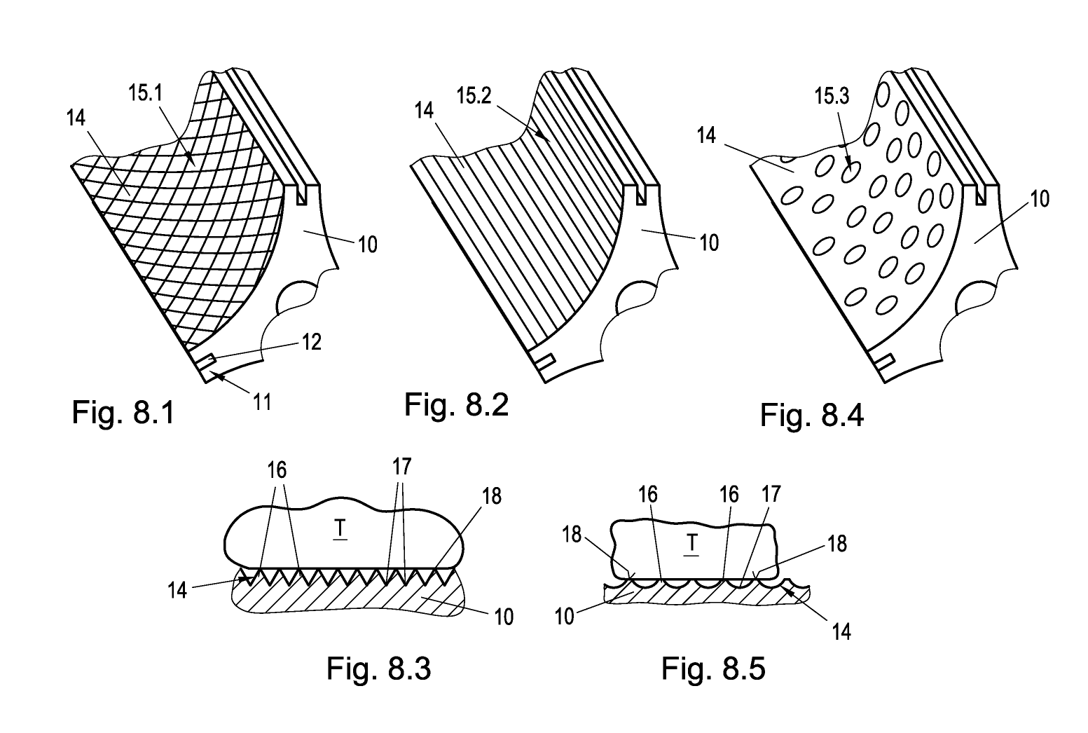

FIG. 8.1, FIG. 8.2 as well as FIG. 8.4 each show in an inclined view details of surfaces of the impeller blades that are provided with different patterns;

FIG. 8.3 shows a sectional view of an impeller blade provided with a pattern according to one depicted in FIG. 8.2;

FIG. 8.5 shows a sectional view of an impeller blade provided with a pattern according to one depicted in FIG. 8.4.

FIG. 1 shows in an isometric inclined view a first embodiment of a cellular roller 1 according to the invention, which is positioned movably around an axis of rotation 2 in the direction of rotation 3, for example in parallel as well as in opposition to a second cellular roller of the same construction that is not depicted in a dough portioning device that is also not shown.

In the circumferential direction there are arranged three positioning chambers 4 that are open on the outside at the same distance or at the same angle 5, respectively. At the front faces of the cellular roller 1 there are provided respectively parts of a central support body 7 provided with fitting flanges, which support body is provided with a shaft bushing 8 for housing a driving shaft not depicted. The support body 7 thus is milled or inserted, respectively, for example, in a basic body 6.

The portioning chambers 4 are limited in the axial direction each by radially arranged impeller blades 10. At the free ends 11 of the impeller blades 10 there are milled longitudinal grooves 12 into a support body 6 forming the impeller blades 10. The integral basic body 6 consists herein of a plastic material 13, which is dough-repellent, anti-bacterial as well as wear-resistant.

The blade surfaces 14 of the impeller blades 10 are provided with a pattern 15, which is formed by elevations 16 or depressions 17, respectively. The depressions 17 are formed in the embodiment herein depicted respectively as approximately hemispherical depressions 17. In operation, there are formed inbetween a dough to be portioned and the blade surface 14, in particular in the volumetrically closed depressions 17, air bubbles, which advantageously reduce the dough contact area. Undesired adhesion of the dough at the rib-like elevations 16 arranged between the depressions 17 thus is reliably prevented.

The longitudinal grooves 12 at the free ends 11 of the impeller blades 10 are intended for the fixation of the reinforcement strips 20 made of a wear-resistant material, e.g., stainless steel, which are form-fittingly inserted in the recesses 12.

FIG. 2.1 as well as FIG. 2.2 each show detailed views of the same embodiment of a reinforcement strip 20, which may be fixed as an elongated strip made of metal 27 in an approximately linear longitudinal groove 12 in an impeller blade 10.

FIG. 2.1 shows the reinforcement strip 20 as well as the impeller blade 10 in an exploded depiction in an inclined view.

FIG. 2.2 depicts the reinforcement strip 20 shown in FIG. 2.1 in an assembled condition fixed in the longitudinal groove 12 of the impeller blade 10. The reinforcement strip 20 is firmly fixed along its first longitudinal edge 21 in the longitudinal groove 12 of the impeller blade 10, for example by means of an adhesive 28. The second longitudinal edge 22 of the reinforcement strip 20 forms its free end and projects beyond the free blade end 11 of the impeller blade 10 by a distance 23 in the radial direction. In this way, the free blade ends 11 of each impeller blade 10, which are especially prone to wear, are each protected against abrasion by way of a reinforcement strip 20.

The FIGS. 3.1 to 3.4 each show in inclined exploded view different embodiment variants of reinforcement strips according to the invention.

FIG. 3.1 depicts a reinforcement strip 20.1, which is provided in the longitudinal direction with a fastening section 24 having a fastening profile 25. The fastening profile 25 is herein embodied as a dove-tail profile 25.1. The impeller blade 10.1 is provided with a longitudinal groove 12 corresponding thereto in order to form-fittingly house the reinforcement strip 20.1.

FIG. 3.2 shows a reinforcement strip 20.2, which is provided in the longitudinal direction with a fastening section 24 having a T-shaped fastening profile 25.2. The impeller blade 10.2, for this reason, is provided with a longitudinal groove 12 having a corresponding cross-section in order to form-fittingly house the reinforcement strip 20.2.

FIG. 3.3 shows a reinforcement strip 20.3 having a fastening section 24 along the longitudinal edge 21, which includes an elliptical fastening profile 25.3. The free longitudinal edge 22, which is in the front in an assembled state and which forms the free end of the reinforcement strip 20.3 and projects in the assembled condition by a distance 23 beyond the free end 11 of the impeller blade 10.3, is provided with a cutting edge 26. The impeller blade 10.3 in turn has a longitudinal groove 12 with a corresponding recess in order to form-fittingly house the reinforcement strip 20.3.

FIG. 3.4 depicts a reinforcement strip 20.4 having a multi-form fastening profile 25.4 with several notches alongside both longitudinal sides of its fastening section 24. The impeller blade 10.4 is provided with a longitudinal groove 12 in order to form-fittingly and precisely house the reinforcement strip 20.4.

FIG. 4 shows another embodiment of a reinforced front edge of an impeller blade 10.5 in an inclined view in an exploded depiction.

FIG. 5 depicts the embodiment of the same impeller blade 10.5 shown in FIG. 4 in a longitudinal section as well as of a reinforcement strip 20.5 in an elevated view.

For the form-fitting fixation, the reinforcement strip 20.5 is herein provided with a fastening profile 25 having several, wedge-like serrated hooks 25.5 that are spaced apart, which may be inserted in the depressions 12.1 accordingly arranged within the longitudinal groove 12. In order to obtain a frictional fixation, the reinforcement strip 20.5 therefore is, for example, knocked into the longitudinal groove 12. By the wedge-like hooks 25.5 made of metal being inserted, however, the depressions 12.1 of the impeller blade 10.5 made of plastic 13 are then deformed within the depressions 12.1. In this embodiment, the reinforcement strip 20.5 may not be opened or replaced any longer after the fixation or the formation, respectively, of the firm connection.

FIG. 6 shows in a partial sectional view a detail of a free blade end 11 of an impeller blade 10 provided with a reinforcement strip 20.6. The reinforcement strip 20.6 is, e.g., connected with the impeller blade 10 made of plastic 13 by way of an insert moulding process. The reinforcement strip 20.6 is provided with a fastening profile having a plurality of hole-like recesses 25.6, which is why, when plastic 13 that forms the blade surface 14 of the impeller blade 14 is insert-moulded, there is obtained an especially secure, form-fitting fixation of the reinforcement strip 20. In insert moulding, the reinforcement strips 20.6 are each surrounded by a plastic 13 up to a measured distance 23 from the free longitudinal edge 21 thereof.

Alternatively, there may be used a reinforcement strip 20.6 also for the firm connection with an impeller blade 10, which is provided with a milled longitudinal groove 12. By way of the fastening profile with hole-like recesses 25.6, the distribution of, e.g., an adhesive is improved. The adhesive may spread within the recesses 25.6 especially easily alongside the adhesive faces between the walls of the longitudinal groove 12 and the reinforcement strip 20.6. This fixation variant is not depicted in the figures.

FIG. 7 shows another embodiment of a cellular roller 1.1 according to the invention, which has a central support body 7 made of metal 27. The central support body 7 is herein formed essentially by a cylindrical tube body, at the external sides of which there are fixed at regular distances three radially projecting reinforcement strips 20.7 by means of welding. The reinforcement strips 20.7 each have a fastening profile with several slit-like recesses 25.7, which are insert-moulded by plastic 13 up to a measured distance 23 from the free front longitudinal edge 22.

Also other, not depicted embodiment variants of cellular rollers, which, e.g., have a different number of portioning chambers than three or wherein the portioning chambers in the circumferential direction of the cellular rollers are not arranged in regular distances but rather at various angles, are comprised by the invention.

FIGS. 8.1 to 8.5 relate to different embodiment forms of the dough-repellent surfaces 14 of the impeller blades 10.

FIG. 8.1 shows in an inclined view a detail of an impeller blade 10, the surface 14 of which is formed by a prism-like or honeycomb-like, respectively, pattern 15.1.

FIG. 8.2 also shows in an inclined view a detailed portion of an impeller blade 10, the surface 14 of which is provided with a dough-repellent pattern 15.2 having longitudinal grooves.

This pattern 15.2 is shown in profile in a very simplified view also in FIG. 8.3. Between the V-shaped depressions 17, there are existent linear elevations 16. A dough T, which is captured and transported by the blade surface 14, therein contacts the impeller blade 10 only at a dough contact area 18, which is essentially formed by the linear elevations 16. Due to the elevations 16 the dough contact area 18 is in an advantageous way significantly reduced in comparison to an impeller blade 10 having a smooth blade surface 14.

FIG. 8.4 shows in an inclined view in a detailed depiction a blade surface 14 provided with approximately hemispherical depressions 17.

FIG. 8.5 depicts in a sectional view a greatly schematized detail of the view in FIG. 8.4 and therein shows a dough T, which contacts the blade surface 14 of the impeller blade 10 only along the rib-like elevations 16, which together form the dough contact area 18. The dough contact area 18, hence, corresponds essentially to the blade surface 14, minus the total area of all approximately hemispherical depressions 17.

### LIST OF POSITION SYMBOLS

1 cellular roller (variant 1.1)

2 axis of rotation

3 direction of rotation

4 portioning chamber

5 angle of division

6 basic body

7 central support body

8 shaft bushing

10 impeller blade (variants 10.1, 10.2 and so on)

11 free blade end

12 longitudinal groove

13 plastic

14 blade surface

15 pattern (variants 15.1, 15.2 and so on)

16 elevations

17 depressions

18 dough contact area

20 reinforcement strip (variants 20.1, 20.2, and so on)

21 (in assembled condition internal) free longitudinal edge of reinforcement strip

22 (in assembled anterior) free longitudinal edge of reinforcement strip

23 measured distance between free longitudinal edge and free blade end

24 fastening section of the reinforcement strip

25 fastening profile

25.1 dove-tail profile

25.2 T-shaped fastening profile

25.3 circular fastening profile

25.4 multi-form fastening profile

25.5 fastening profile with hook

25.6 fastening profile with hole-shaped recesses

25.7 fastening profile with slit-shaped recesses

26 cutting blade

27 metal

28 adhesive

T dough

1. A cellular roller for portioning dough, comprising a plurality of impeller blades, each impeller blade radially extending from a central axis of rotation and each impeller blade having a blade surface made of dough-repellent plastic, wherein adjacent impeller blades define a portioning chamber therebetween that is open on the outside, and wherein each impeller blade at the an open blade end thereof comprises a reinforcement strip comprising an abrasion-resistant material.

2. The cellular roller according to claim 1, wherein each reinforcement strip projects beyond the open blade end of each impeller blade in a radial direction by a measured distance of from 0.1 mm to 25 mm.

3. The cellular roller according to claim 1, wherein each reinforcement strip has a fastening profile extending in a longitudinal direction of the cellular roller.

4. The cellular roller according to claim 3, wherein the fastening profile comprises fastening hooks.

5. The cellular roller according to claim 1, wherein each reinforcement strip comprises recesses.

6. The cellular roller according to claim 1, wherein each reinforcement strip comprises a cutting edge along its a free longitudinal edge of the reinforcement strip.

7. The cellular roller according to claim 1, wherein each reinforcement strip is housed respectively in a longitudinal direction of the cellular roller in a longitudinal groove at the open blade end of each impeller blade.

8. The cellular roller according to claim 7, wherein each reinforcement strip is firmly and/or form-fittingly fixed in its respective longitudinal groove.

9. The cellular roller according to claim 1, wherein the reinforcement strips are metal.

10. The cellular roller according to claim 1, wherein the portioning chambers are arranged in a circumferential direction of the cellular roller at regular distances.

11. The cellular roller according to claim 1, wherein each blade surface comprises a pattern of elevations and/or depressions.

12. The cellular roller according to claim 11, wherein a dough contact area formed by the elevations and/or depressions accounts for from 10% to 90%, of the impeller blade surface.

13. The cellular roller according to claim 1, wherein the dough-repellent plastic is antibacterial.

14. The cellular roller according to claim 1, wherein the reinforcement strips are integrated in an integral basic body comprising dough-repellent plastic.

15. The cellular roller according to claim 1, wherein the reinforcement strips are insert-moulded with dough-repellent plastic up to a measured distance of from 0.1 mm to 25 mm, preferably from 0.5 to 5 mm, which is measured in the a radial direction from the a free longitudinal edge of the reinforcement strip.

16. The cellular roller according to claim 15, wherein the reinforcement strips are connected with a central support body.

17. The cellular roller according to claim 1, wherein each reinforcement strip projects beyond the open blade end of each impeller blade in a radial direction by a measured distance of from 0.5 mm to 5 mm.

18. The cellular roller according to claim 1, wherein the reinforcement strips are a non-corrosive metal.

19. The cellular roller according to claim 11, wherein a dough contact area formed by the elevations and/or depressions accounts for from 15% to 80% of the impeller blade surface.

20. The cellular roller according to claim 1, wherein the reinforcement strips are insert-moulded with dough-repellent plastic up to a measured distance of from 0.5 mm to 5 mm which is measured in a radial direction from a free longitudinal edge of the reinforcement strip.

21. The cellular roller according to claim 15, wherein the reinforcement strips are connected with a central support body by welding or integrally.
